(19) United States
(12) Patent Application Publication
(10) Pub. No.: US 2004/0073480 A1
(43) Pub. Date: Apr. 15, 2004

(54) Method of providing a credit card driven tuition incentive awards program

(76) Inventor: Shlomo Nahmias, Brooklyn, NY (US)

Correspondence Address: RICHARD L. MILLER, 12 Parkside Drive, Dix Hills, NY, 11746-4879, US

(21) Appl. No.: 09/729,323

(22) Filed: Dec. 4, 2000

(51) Int. Cl. G06F 17/60

(52) U.S. Cl. 705/14; 705/39

(57) ABSTRACT

A program vendor teams up with a credit card issuer who gives the program vendor a certain percentage of the sales made by a member card holder. The program vendor than appropriates a certain percentage of this amount and forwards it to the card holder for participating in the tuition incentive awards program.

### BACKGROUND OF THE INVENTION

1. Field of the Invention

The present invention relates to a method of providing a tuition incentive awards program. More particularly, the present invention relates to a method of providing a credit card driven tuition incentive awards program.

2. Description of the Prior Art

Numerous innovations for incentive award systems have been provided in the prior art that will be described. Even though these innovations may be suitable for the specific individual purposes to which they address, however, they differ from the present invention.

A FIRST EXAMPLE, U.S. Pat. No. 5,025,372 to Burton et al. teaches computer data processing, programming and printing for an improved incentive award program which allocates monetary amounts available for expenditure through credit instruments issued to program participants when the participants perform to a designated level of achievement. Participants identifying information and credit instrument account numbers are stored in memory. The incentive program can be divided into multiple time periods. Levels of performance are calculated and assigned for each participant in order for a monetary amount to be available for expenditure through the participant's credit instrument. Monetary amounts can be withheld from the amounts allocated to the instrument accounts. Adjustments can be made in the withheld amounts and in the achievement levels. Calculations, adjustment and reporting concerning amounts allocated for instrument use, withheld amounts, instrument transactions and account balances are made. Calculations and printed invoices for payment by a financial institution to an incentive company based on the credit instruments issued under the incentive program are made and are dependent upon the monetary volume of expenditures through the credit instruments, the total interest income on the credit instruments, and the number of instruments issued. The tradename or trademark of the company sponsoring the program can appear on the physical credit instruments and on statements provided to participants. Travel and merchandise awards are integrated with the credit instrument program.

A SECOND EXAMPLE, U.S. Pat. No. 5,056,019 to Schultz et al. teaches a marketing method for providing manufacturer purchase reward offers by automatically tracking the purchases of member consumers through the use of bar coded membership cards and using the purchase records in a data processing system to determine if the required purchases have been made to earn a reward. Each member consumer receives a reward booklet disclosing the available reward offers, a periodic status report indicating the member consumer's progress toward earning rewards, and a reward certificate for those rewards earned.

A THIRD EXAMPLE, U.S. Pat. No. 5,297,026 to Hoffman teaches a system and data processing arrangement for promoting purchases and account activity in a credit card account or other consumer transaction involving sales of goods or services rewards a customer for purchases by providing a high rate of return for funds invested by the customer. A financial institution, general purpose credit card agency, department store, automobile manufacturer, or various other marketers of goods or services agrees to grant the customer a high rate of interest on funds invested with the firm by the customer, provided the customer makes purchases. For purchases made by the customer in a given period (such as one month or six months), the firm gives the customer the right to invest a certain percentage (such as 10%) of the amount of purchases made by the customer in that period. Using automated data processing, the firm calculates the sum of the total purchases made by the customer during the preselected period. Then, funds are accepted from the customer up to the pre-agreed percentage of purchases, and provides a deposit account for the customer, crediting the investment funds in the deposit account. The firm may limit the term during which interest is paid on accepted funds invested for a particular such period, such as a term of six months or one year, or it may simply lower the interest rate at the end of that term.

A FOURTH EXAMPLE, U.S. Pat. No. 5,983,196 to Wendkos teaches a computer implemented system awards promotional incentives. A participant in the awards system calls or connects to an interactive platform for registering and/or redeeming credits preferably described in uniquely identified certificates. In a telephone environment, the interactive platform is connected to a toll free telephone number where a participant's call is handled by a computer controlled voice response unit. In a computer network environment, a computer user connects to the interactive platform over the network. The participant receives awards credits based on the unique identification of certificates. Award credits for a participant are accumulated in a stored record associated with the participant until redeemed. Award credits can also be acquired as an instant winner based on a random or algorithmic selection of callers to receive such credits. Awards include electronic prizes such as free long distance telephone time, electronic cash and/or service credits. Connection to the interactive platform may occur during execution of an application program such as an electronic game or electronic shopping.

A FIFTH EXAMPLE, U.S. Pat. No. 5,991,736 to Ferguson et al. teaches a patronage incentive system in which a monetary award is made to a customer's retirement account as incentive for the customer to participate in a transaction with the sponsor for the sponsor's goods or services. The system includes a means for identifying the customer, a means for inputing the identification information and other information about the transaction into a computer data storage, a computer data processing device which uses a software program along with the transactional information to calculate an incentive award amount a means for transferring the monetary funds equal to the incentive award amount from an incentive award pool to the customer's retirement account, and a means of reporting the incentive award amount to the customer and to the sponsor. Embodiments of a method of conducting a patronage incentive system of the present invention are also disclosed comprising the steps of inputing transactional information into a computer data storage device, calculating the incentive award amount through the use of a computer data processing device, transferring monetary funds equal to the incentive award amount from an incentive award pool to the customer's retirement account, and reporting the incentive award amount to the customer and to the sponsor.

It is apparent that numerous innovations for incentive award systems have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a method of providing a credit card driven tuition incentive awards program that avoids the disadvantages of the prior art.

ANOTHER OBJECT of the present invention is to provide a method of providing a credit card driven tuition incentive awards program that is simple and inexpensive to manufacture.

STILL ANOTHER OBJECT of the present invention is to provide a method of providing a credit card driven tuition incentive awards program that is simple to use.

BRIEFLY STATED, YET ANOTHER OBJECT of the present invention is to provide a method of providing a credit card driven tuition incentive awards program wherein a program vendor teams up with a credit card issuer who gives the program vendor a certain percentage of the sales made by a member card holder. The program vendor than appropriates a certain percentage of this amount and forwards it to the card holder for participating in the tuition incentive awards program.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1UU are a flow chart of the present invention.

LIST OF REFERENCE NUMERALS UTILIZED IN THE DRAWING

| | |
|---|---|
| 10 | credit card driven tuition incentive awards program of present |
| | invention |
| 12 | agreement between credit card issuer 14 and program vendor 16 |
| 14 | credit card issuer |
| 16 | program vendor |
| 18 | percentage of credit card sales |
| 20 | predetermined period |
| 22 | FDIC insured bank accounts |
| 24 | set interest collecting on FDIC insured bank accounts 22 |
| 26 | cost of operations of program vendor 16 |
| 28 | potential credit card holder |
| 30 | credit card |
| 32 | credit card holder |
| 34 | annual fee for credit card holder to participate in credit card |
| | driven tuition incentive awards program 10 |
| 36 | account of credit card holder 32 |
| 38 | balance of account 36 of credit card holder 32 |
| 40 | account balance of account 36 of credit card holder 32 |
| 42 | amount |
| 43 | amount charged on credit card 30 |
| 44 | certain percentage 44 of amount charged 42 on credit card 30 |
| 46 | points |
| 48 | points accumulated |
| 50 | telephone |
| 52 | Internet |
| 54 | predetermined amount of points accumulated 48 |
| 56 | dollars |
| 58 | dollar amount |
| 60 | check in dollar amount 58 |
| 62 | student |
| 64 | name of student 62 |
| 66 | school attended by student 62 |
| 68 | tuition of school 66 attended by student 62 |
| 70 | problem getting check 60 to school 66 |
| 72 | distinct code number of each school 62 |
| 74 | confirmation |
| 76 | mail confirmation |
| 78 | e-mail confirmation |
| 80 | call |
| 82 | automated telephone call |
| 84 | Internet call |

### DETAILED DESCRIPTION OF THE PREFERRED EMBODIMENT

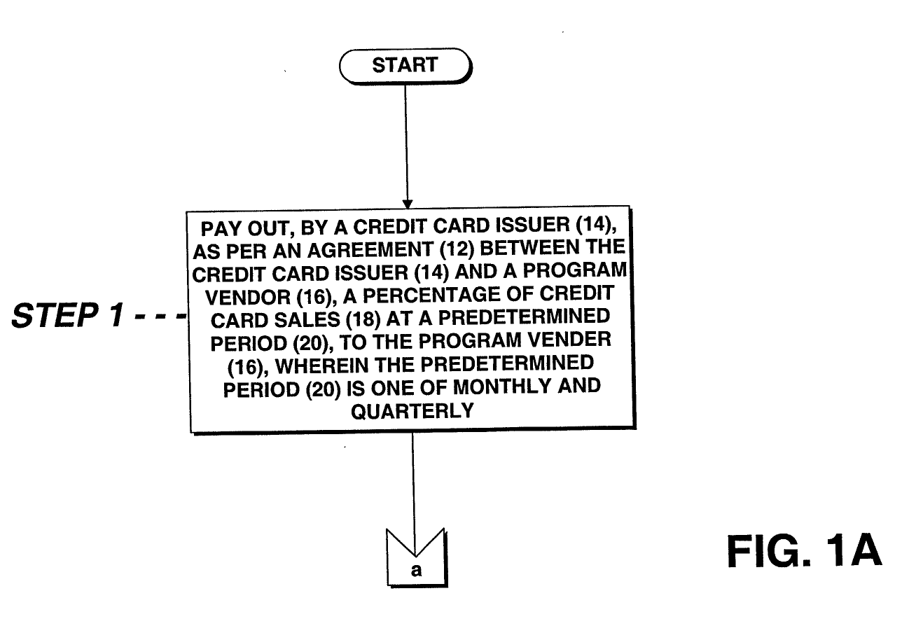

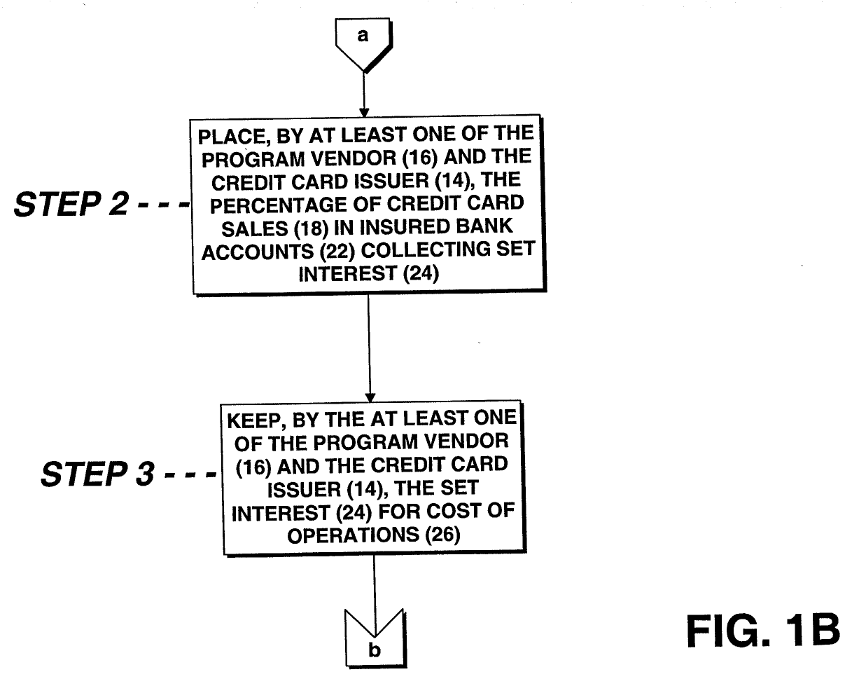

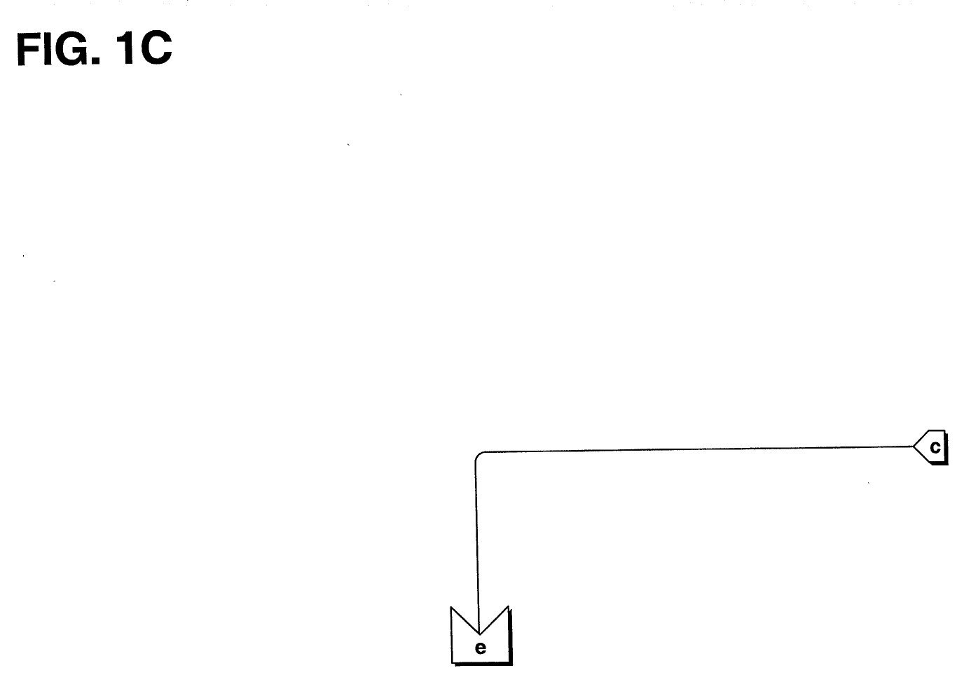

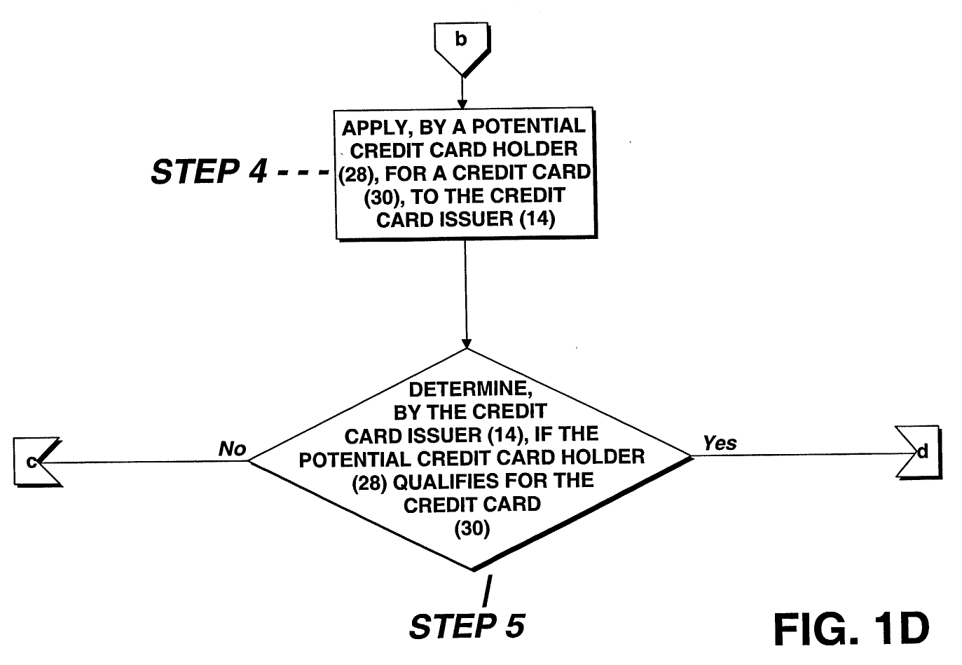

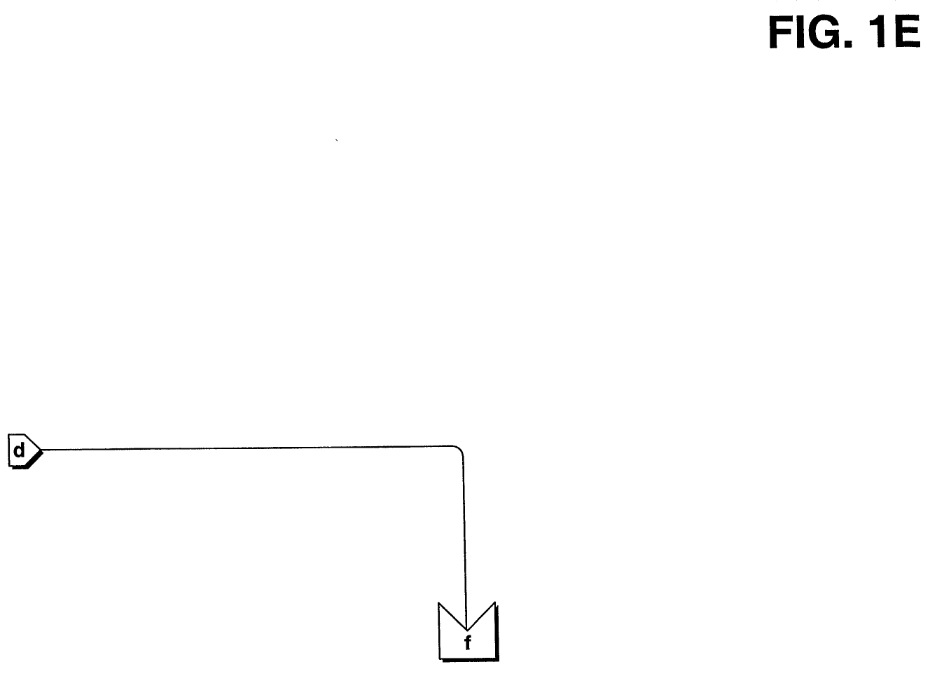

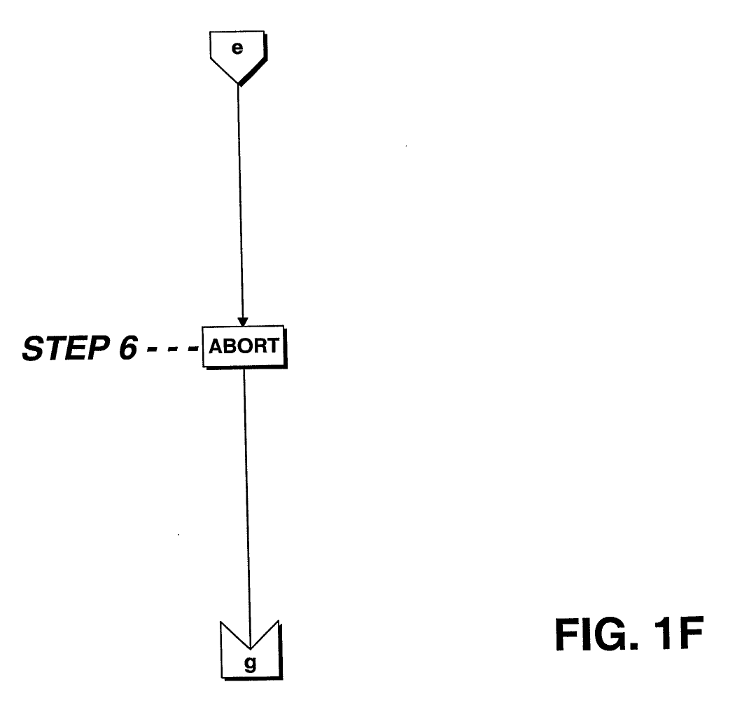

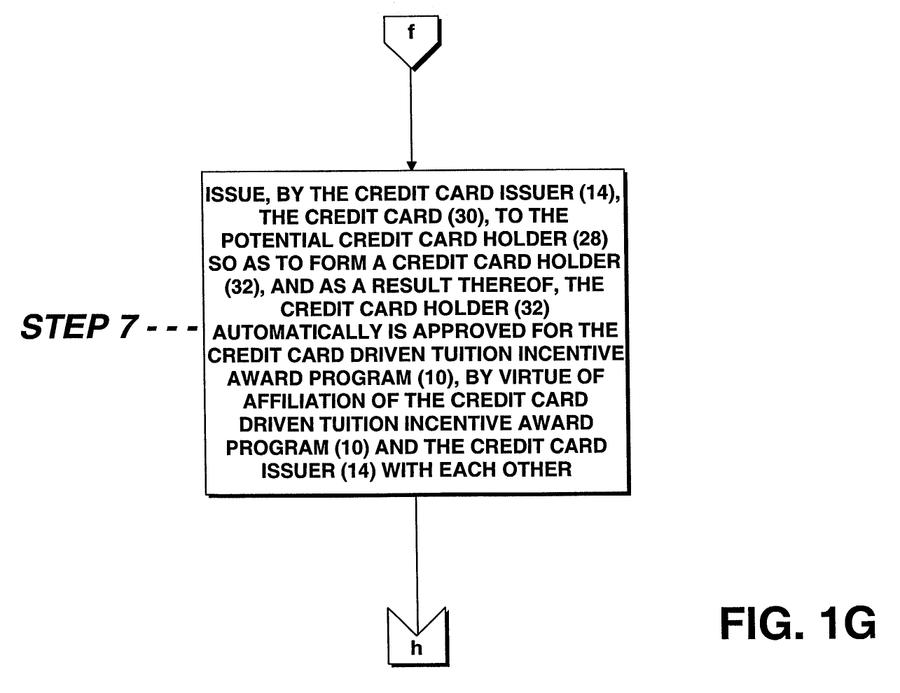

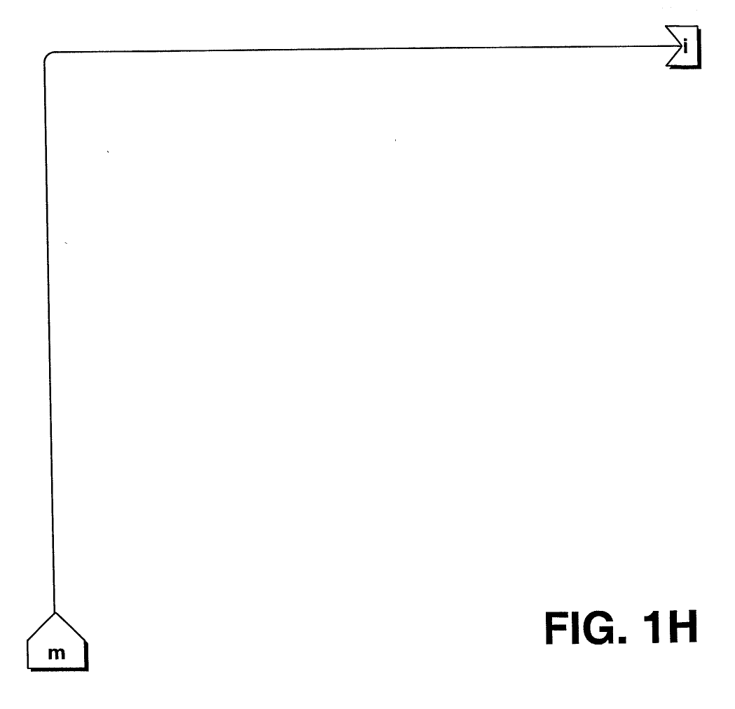

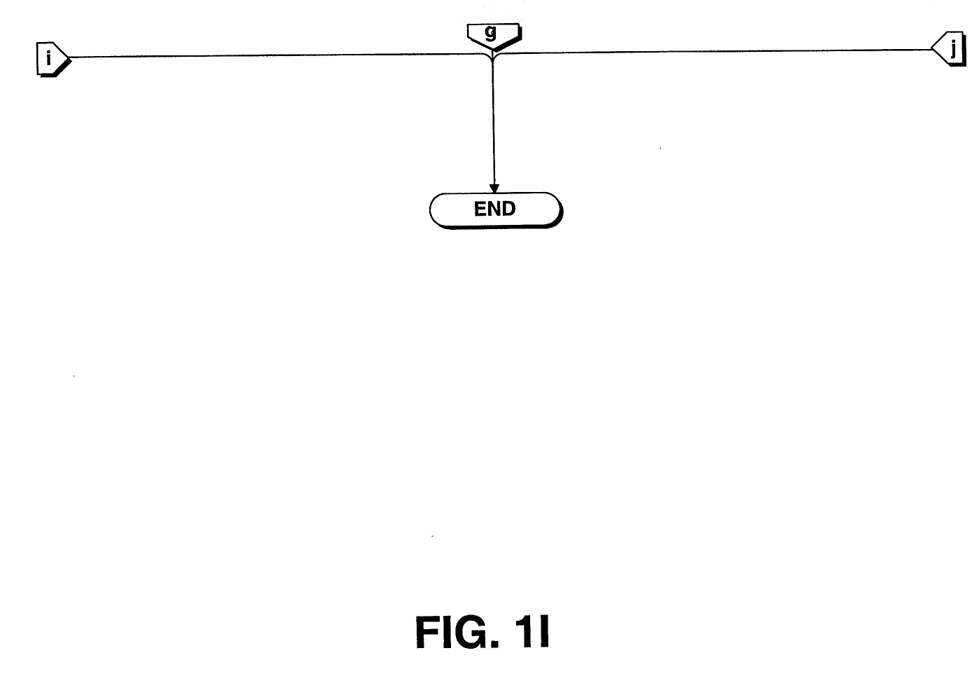

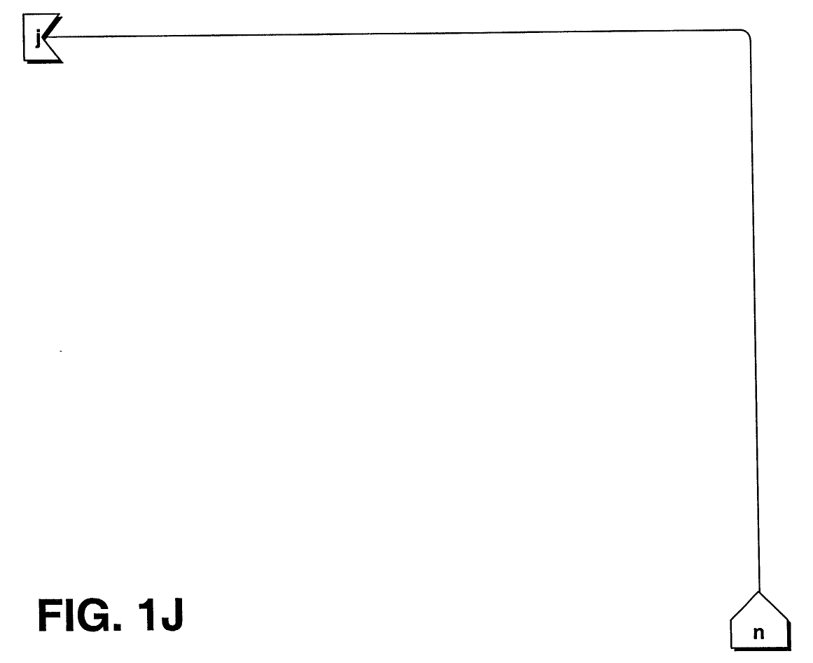

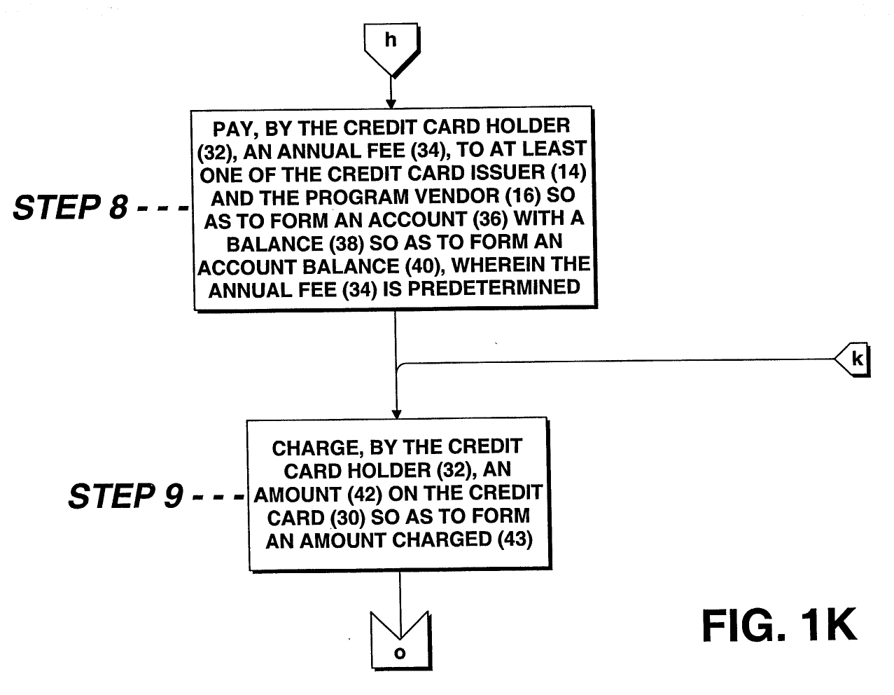

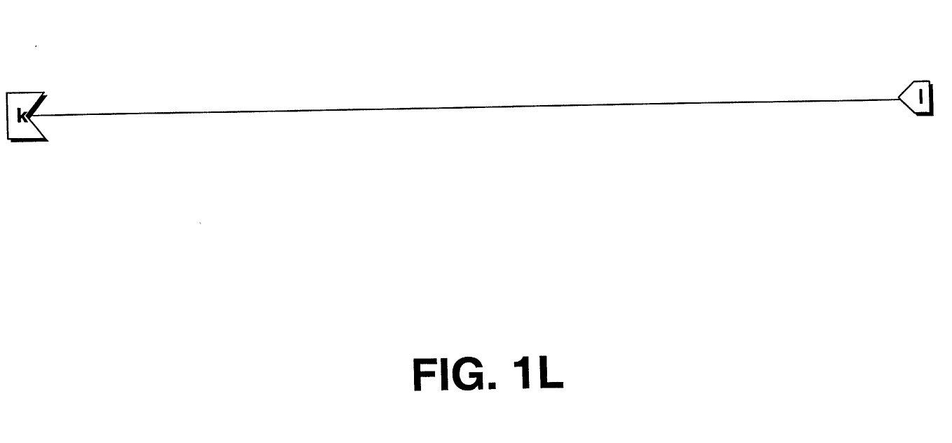

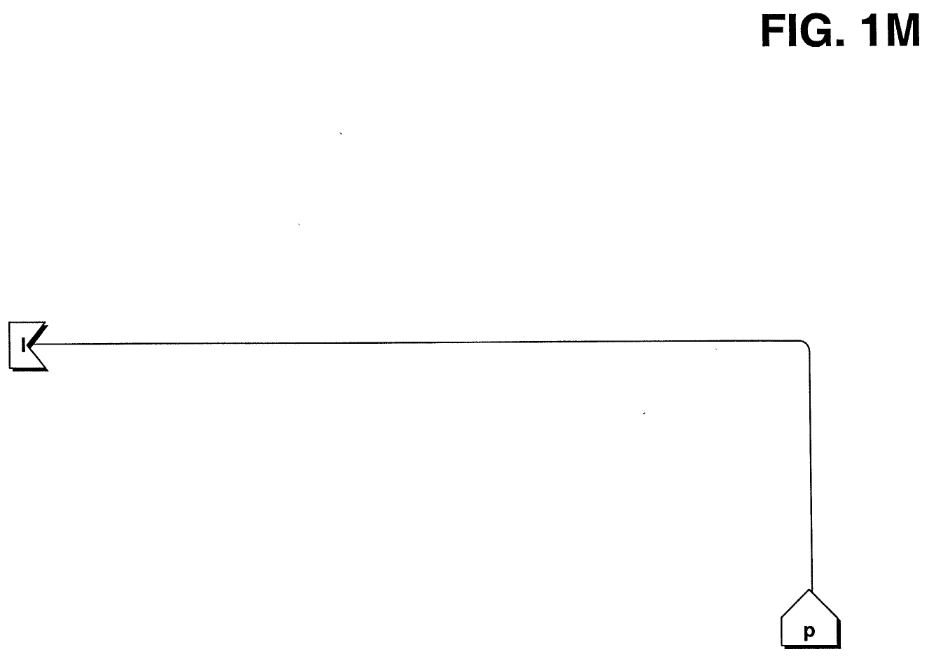

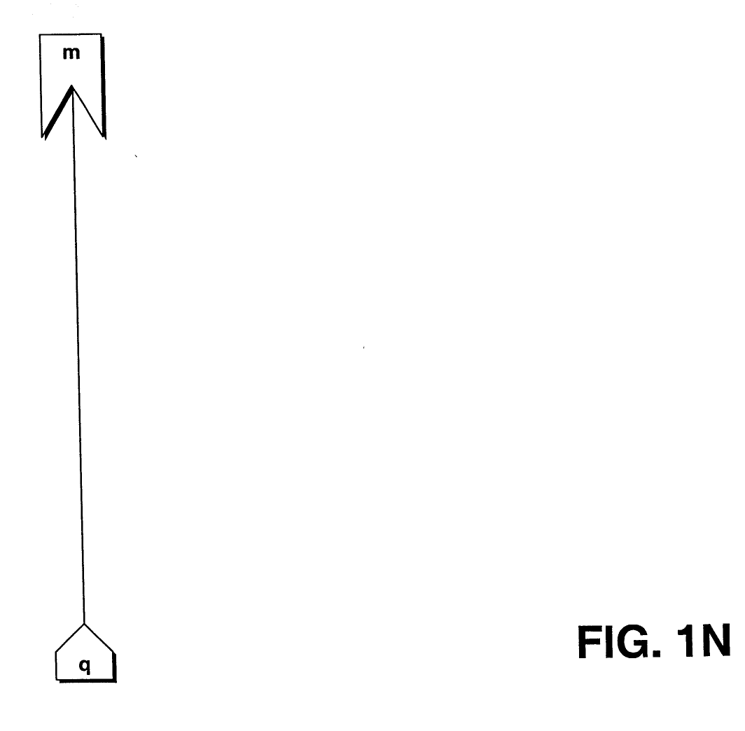

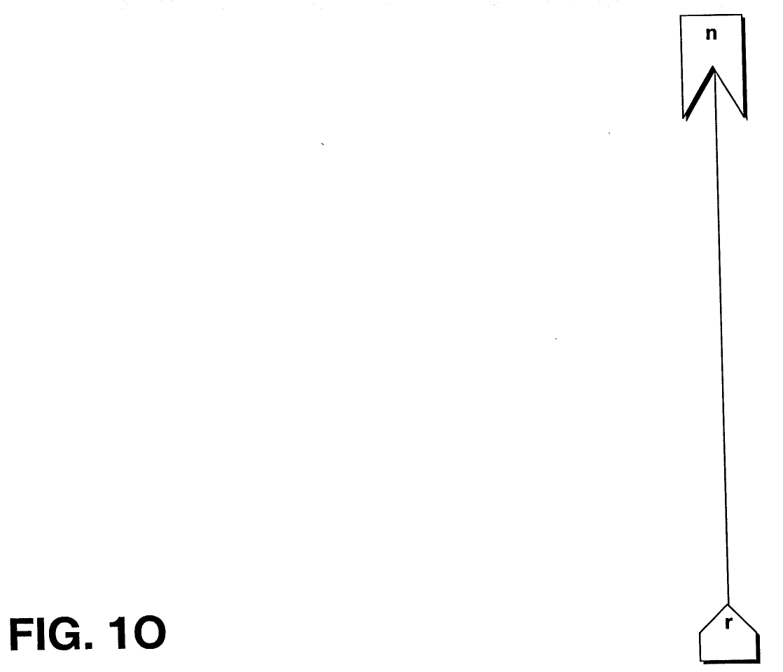

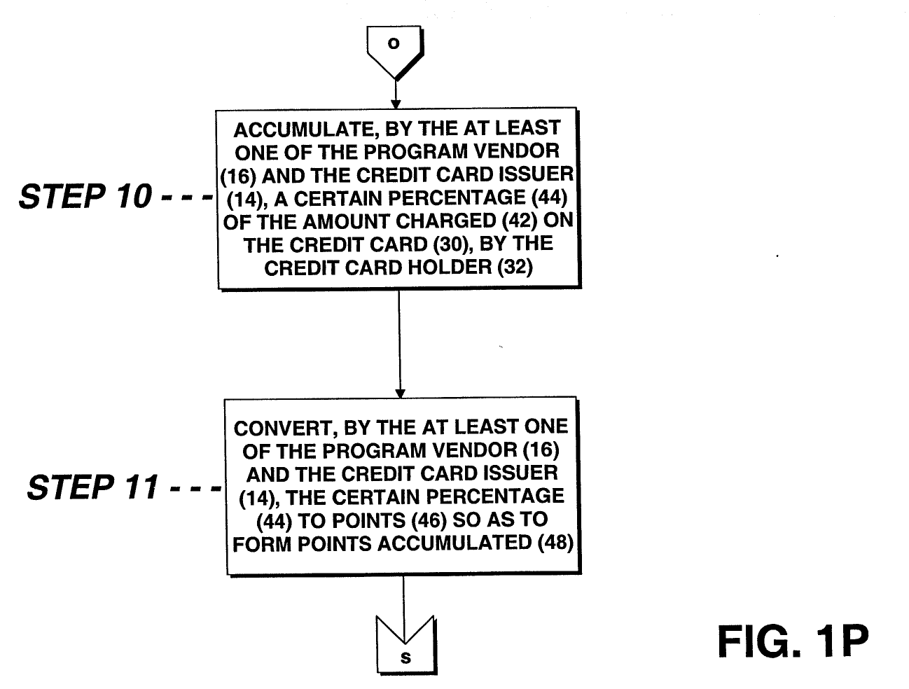

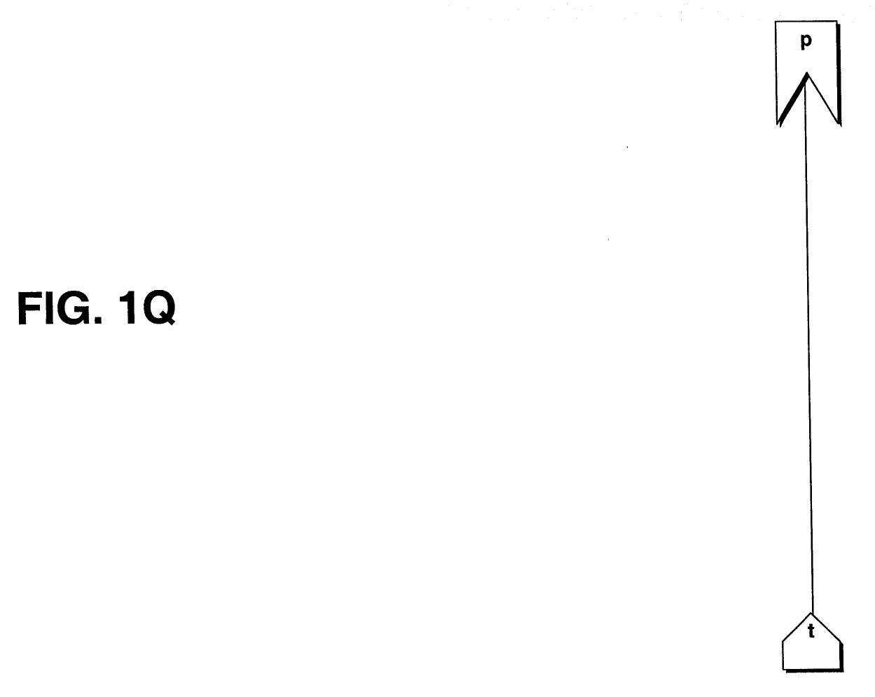

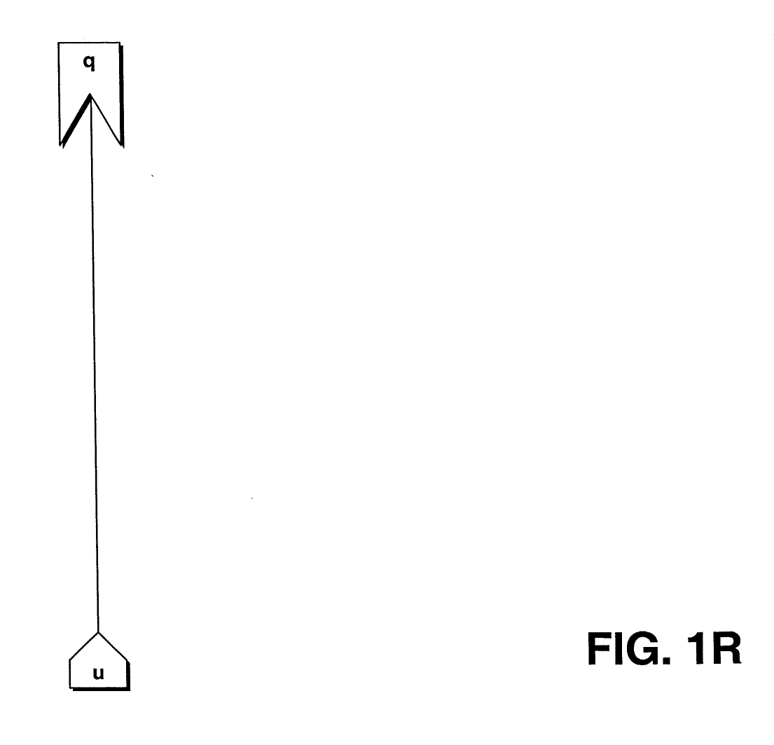

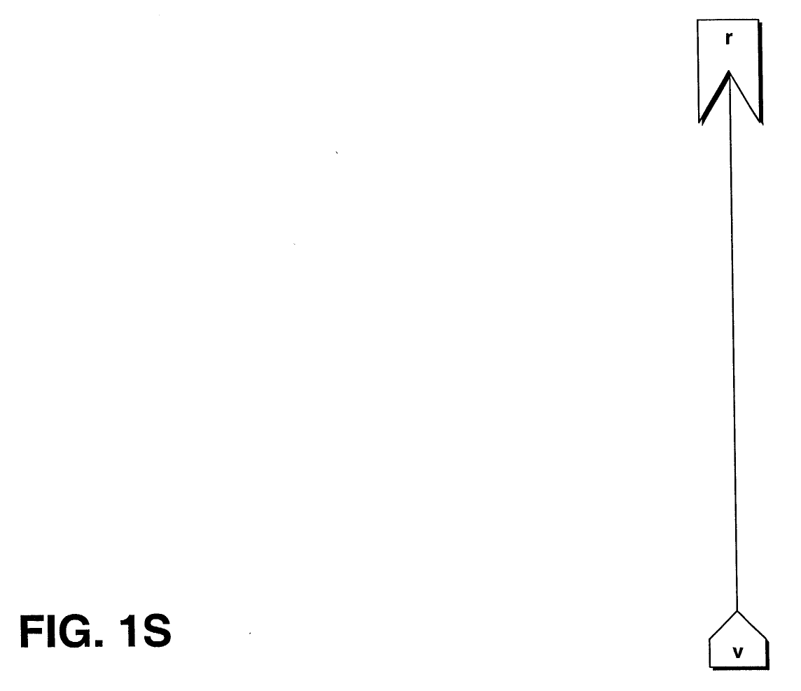

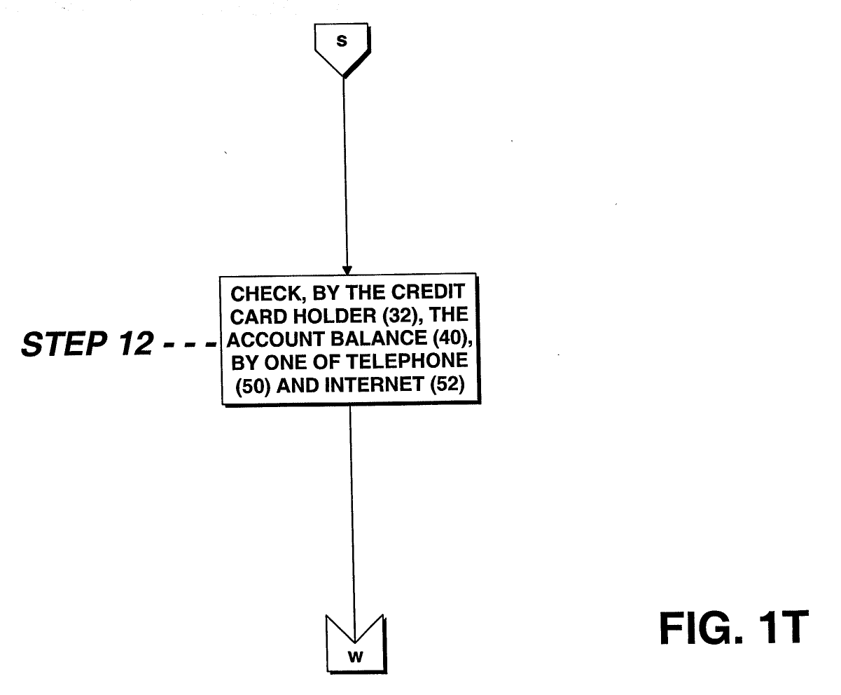

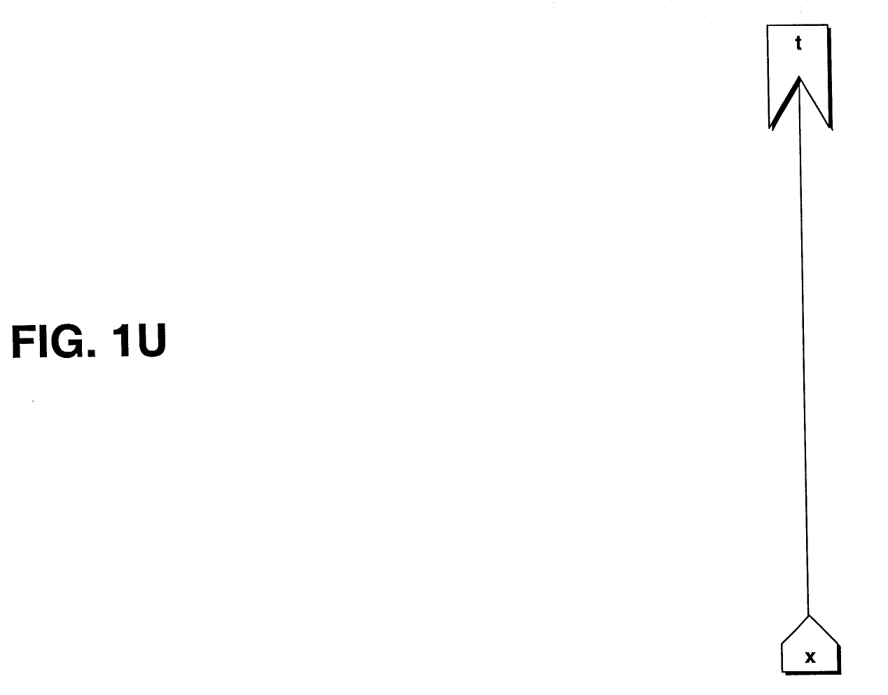

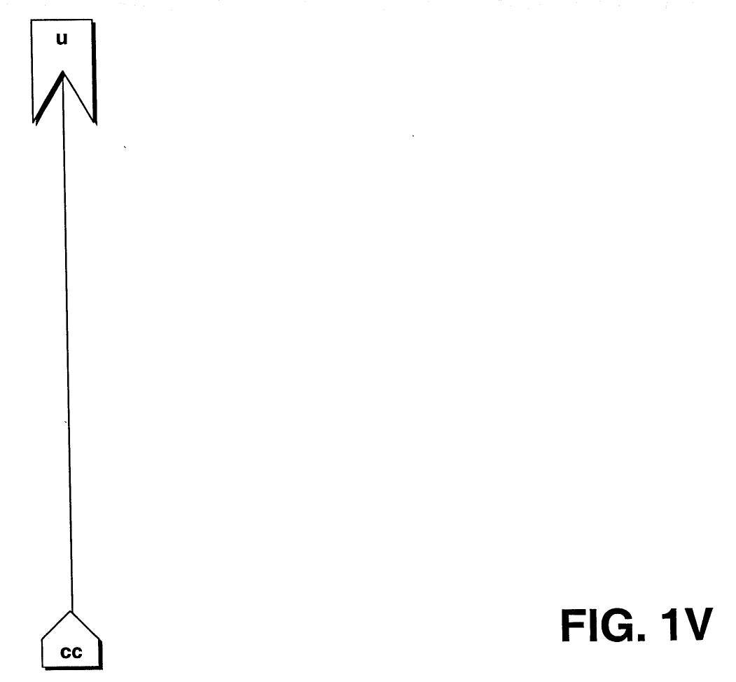

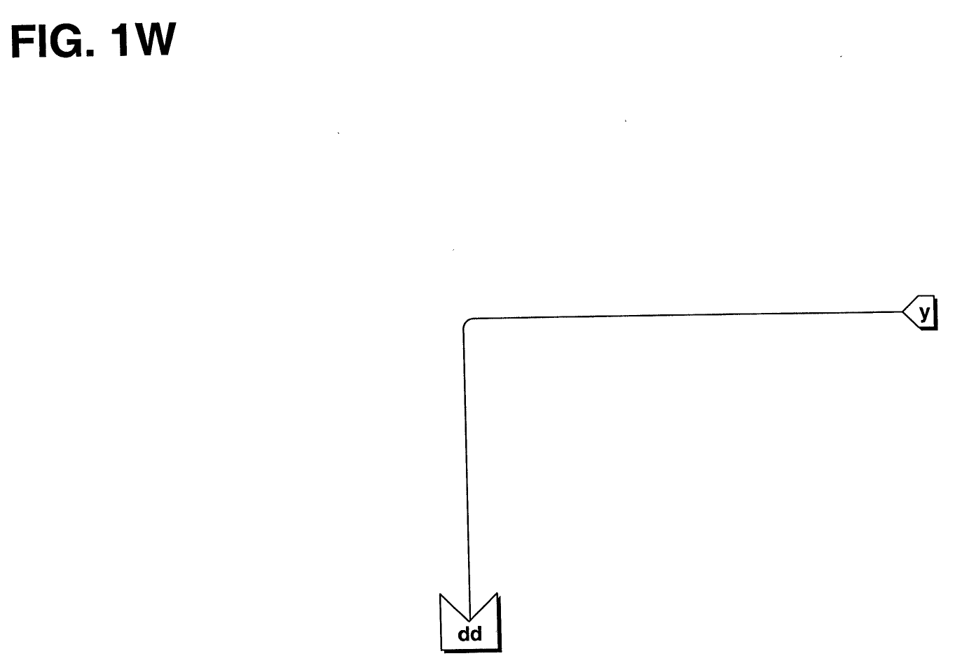

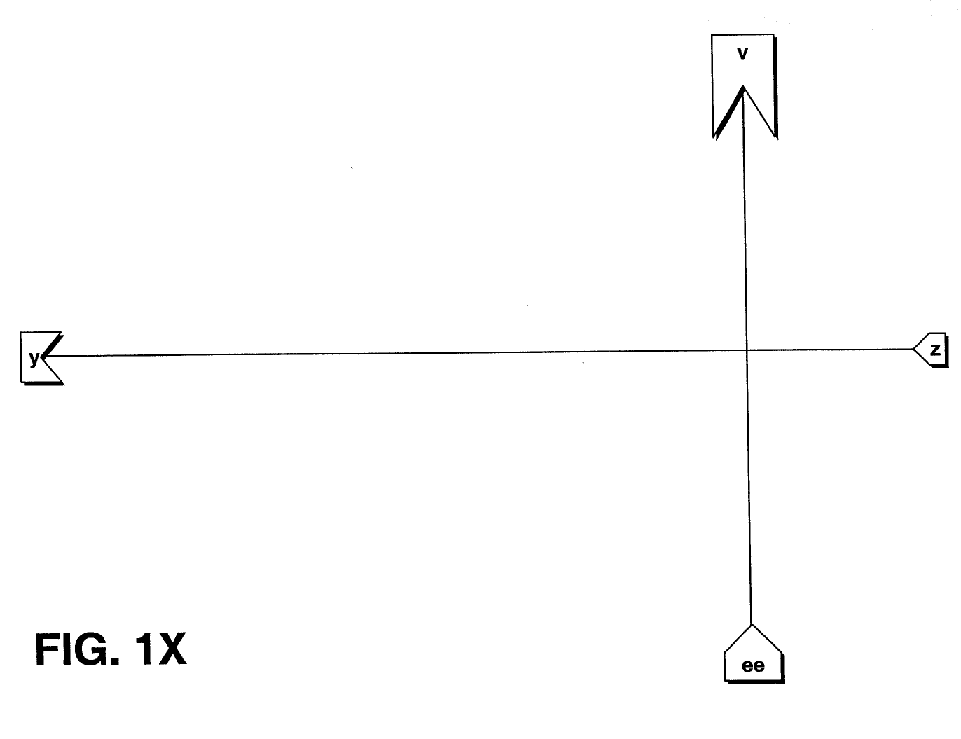

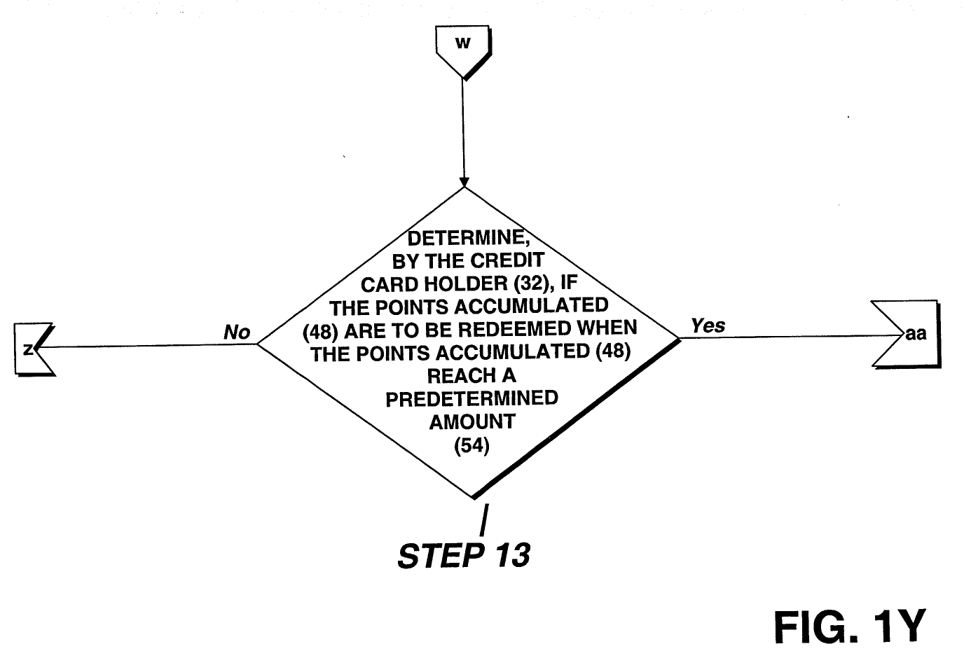

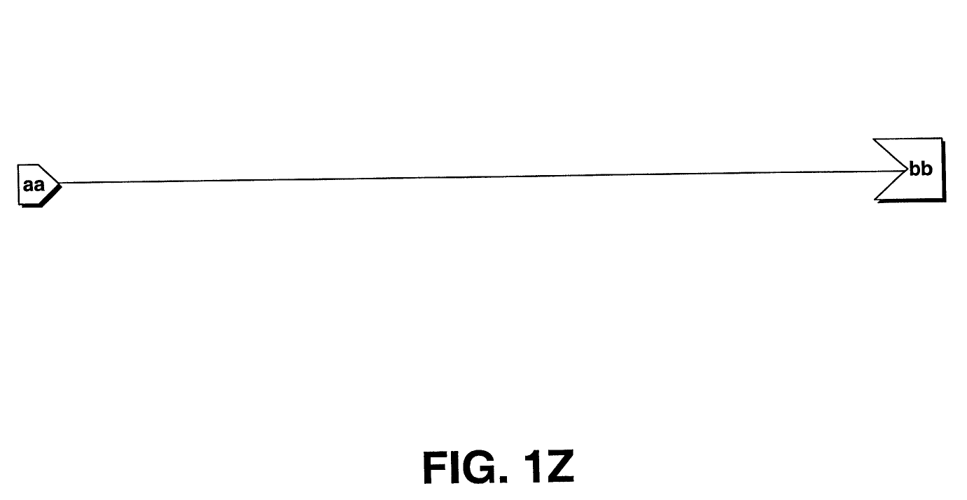

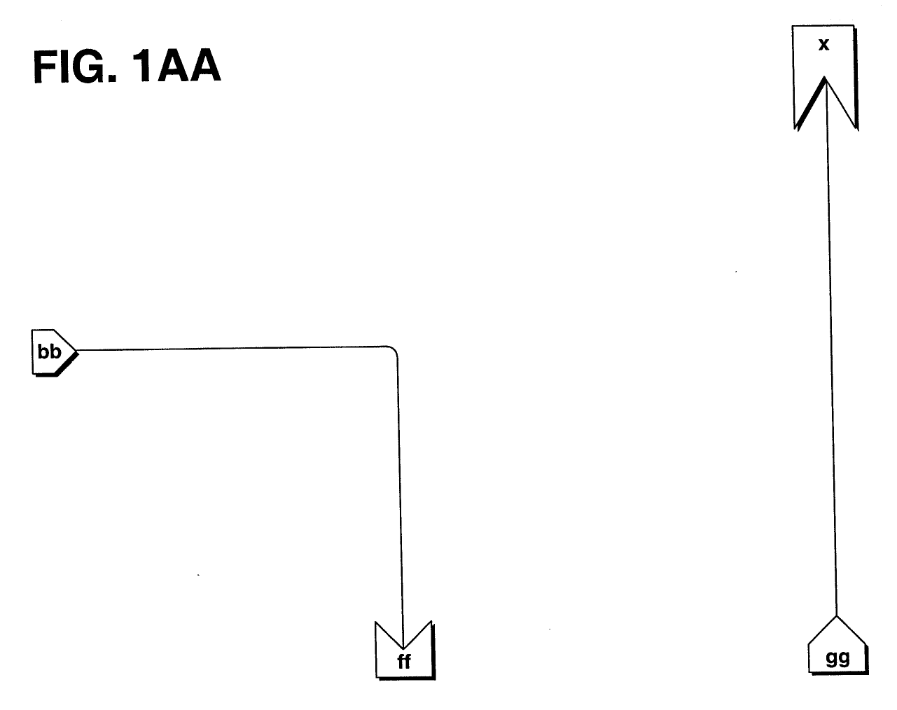

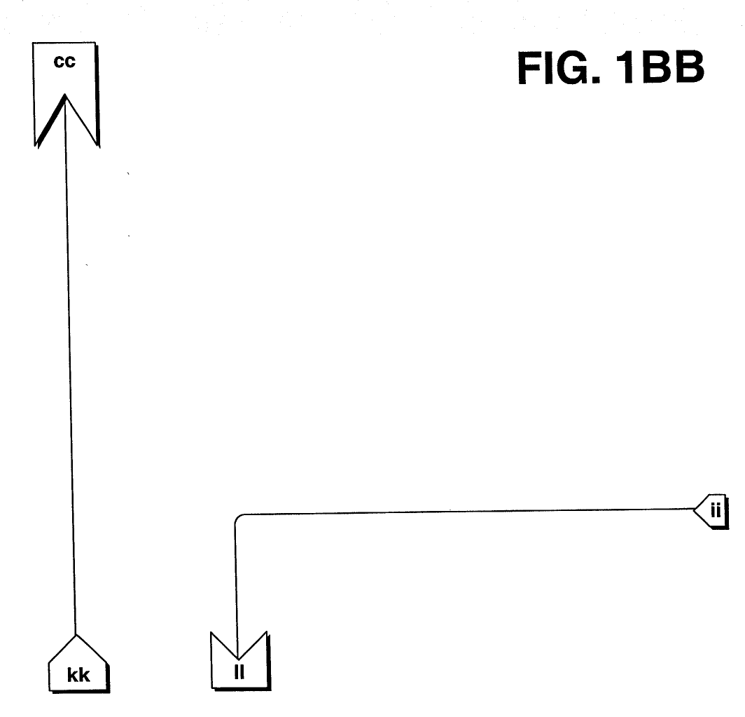

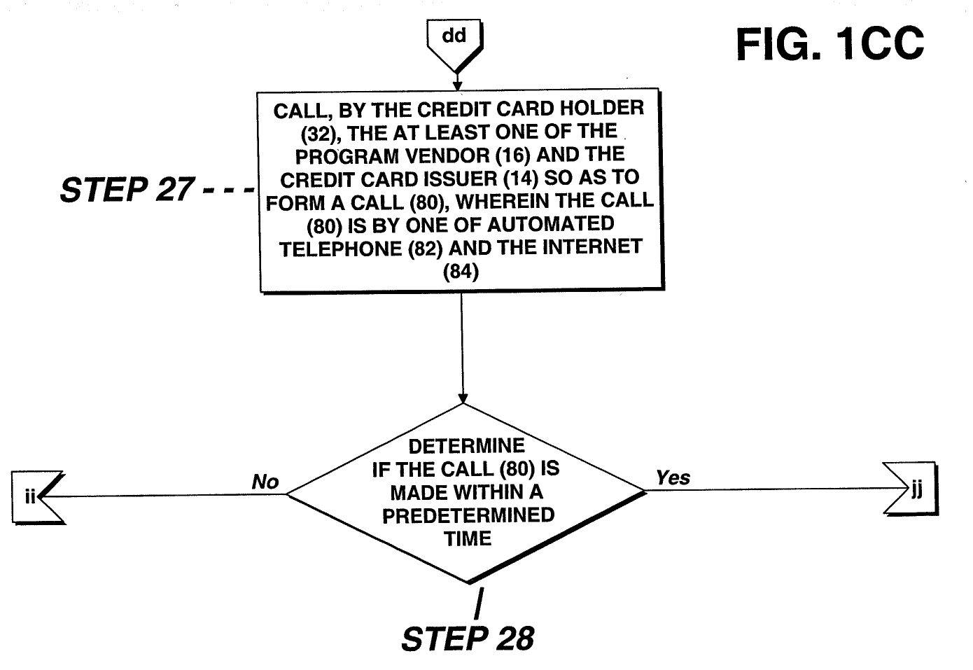

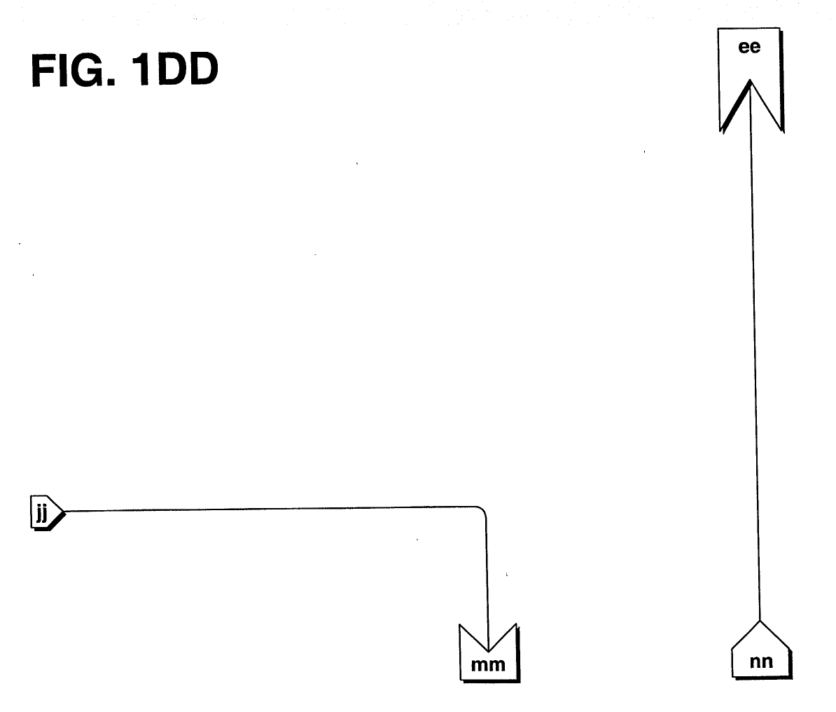

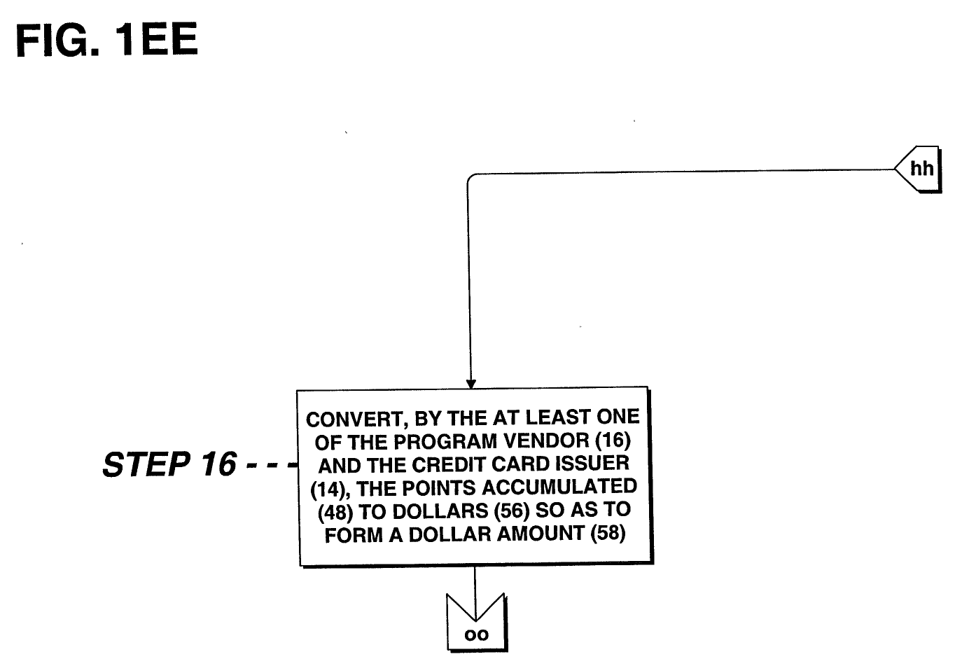

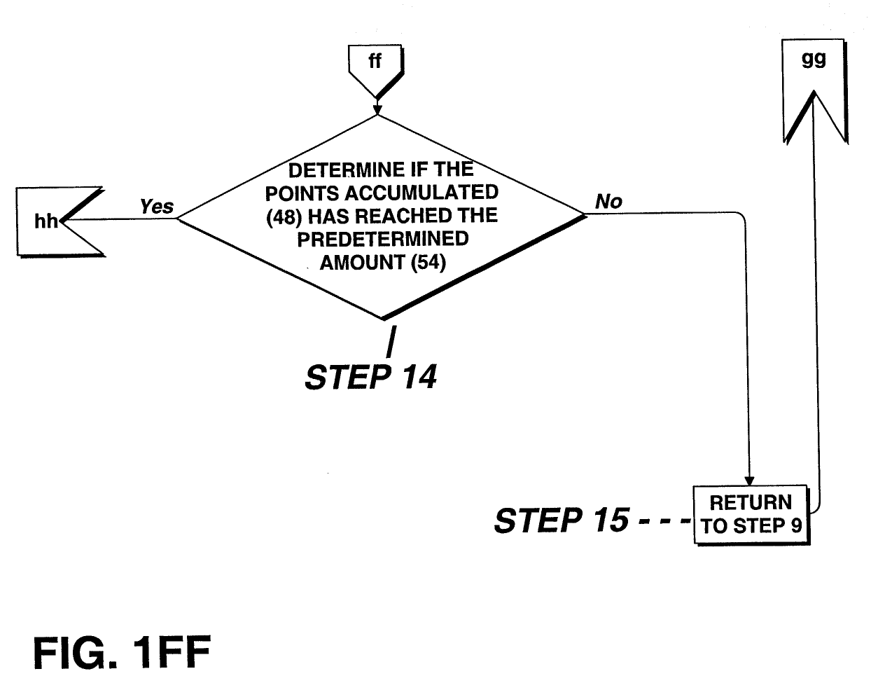

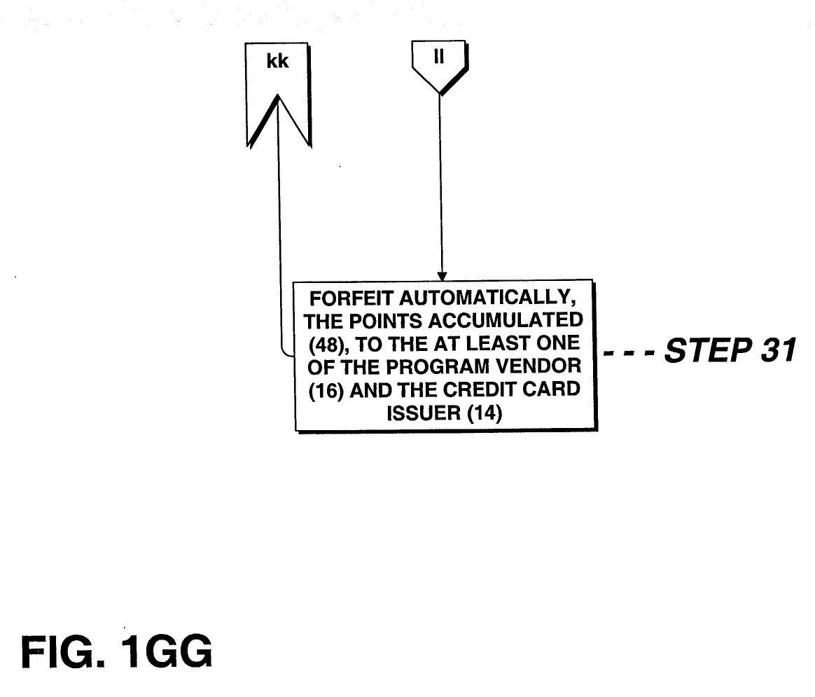

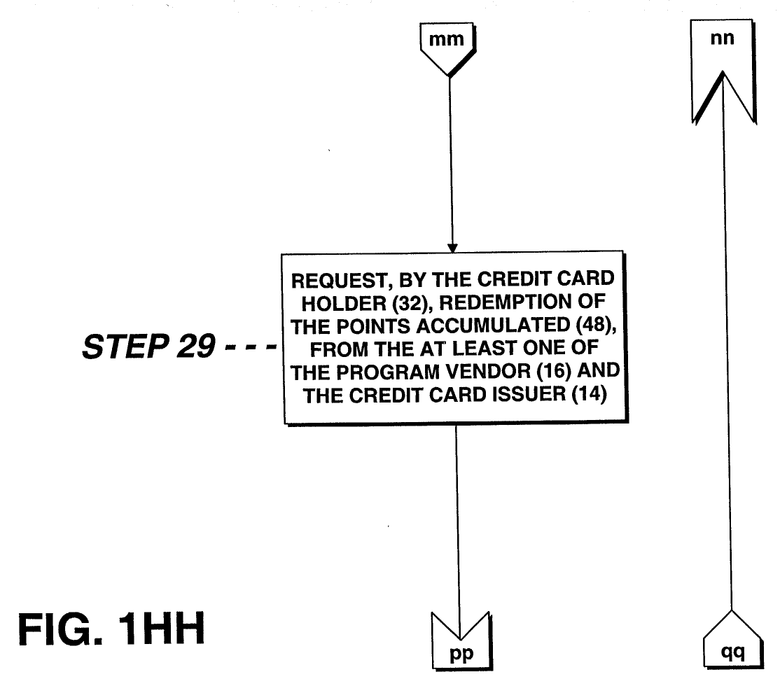

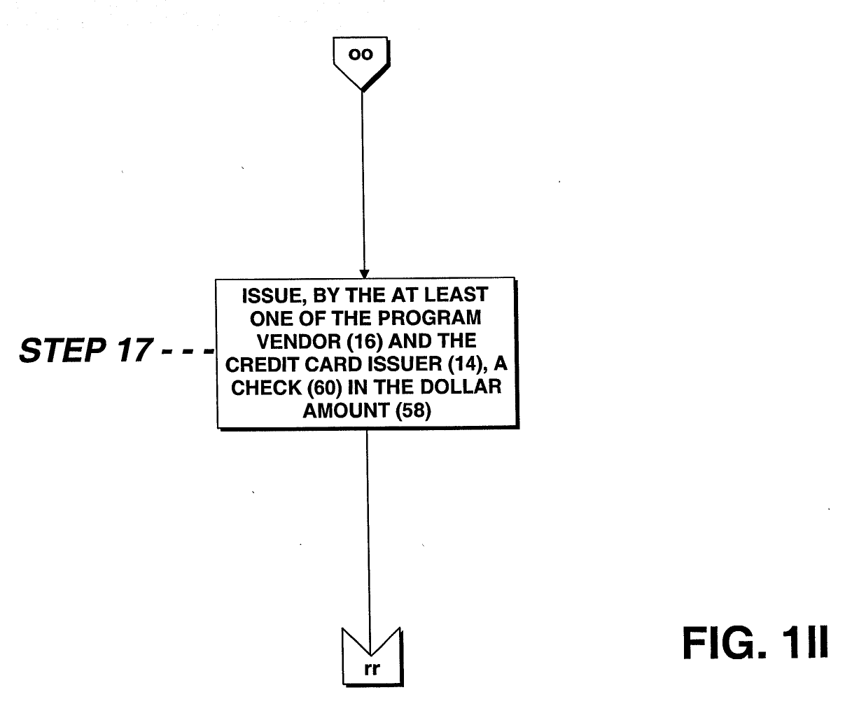

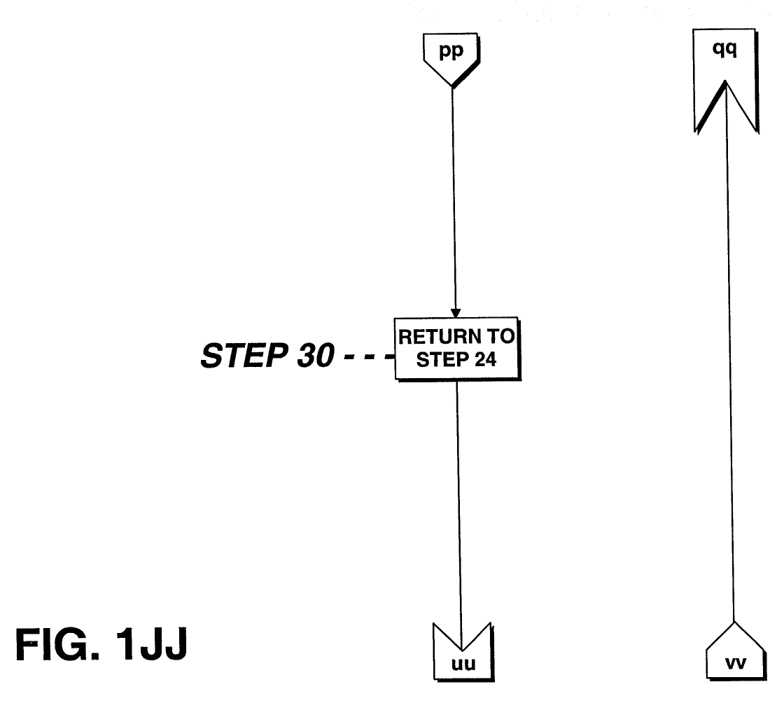

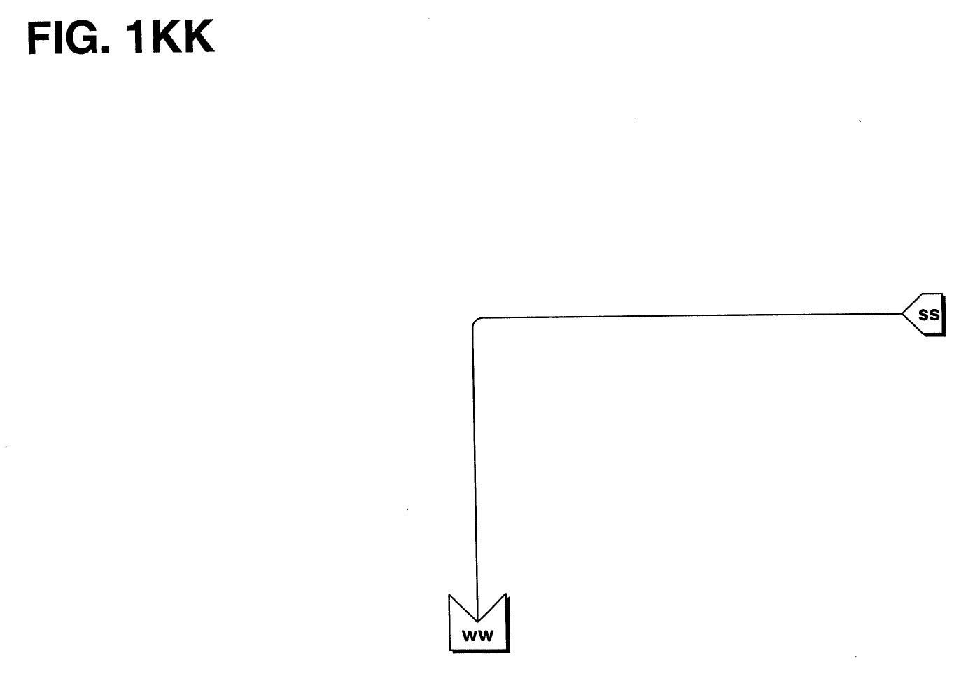

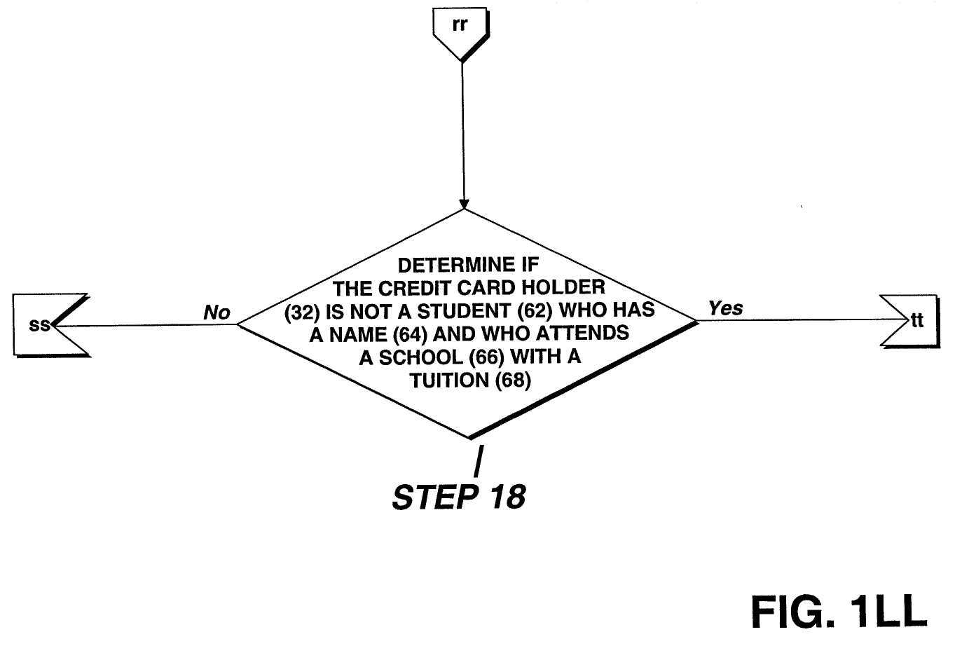

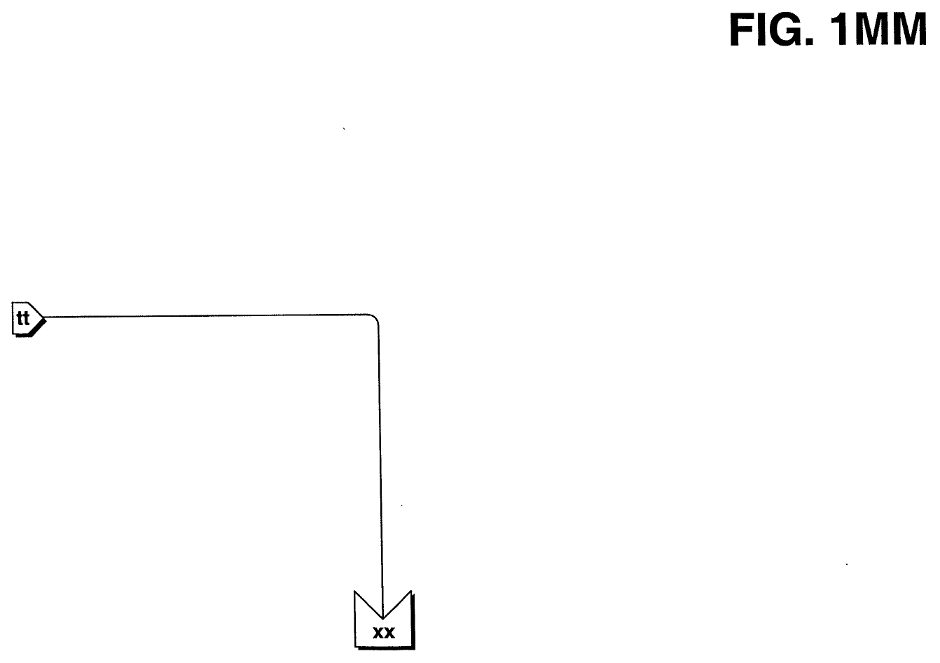

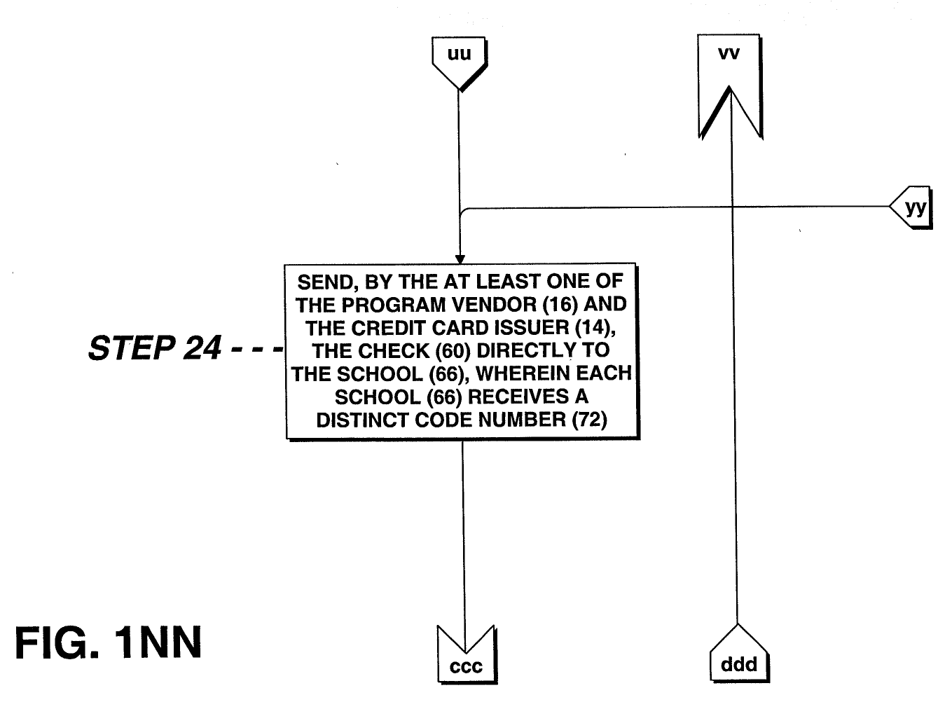

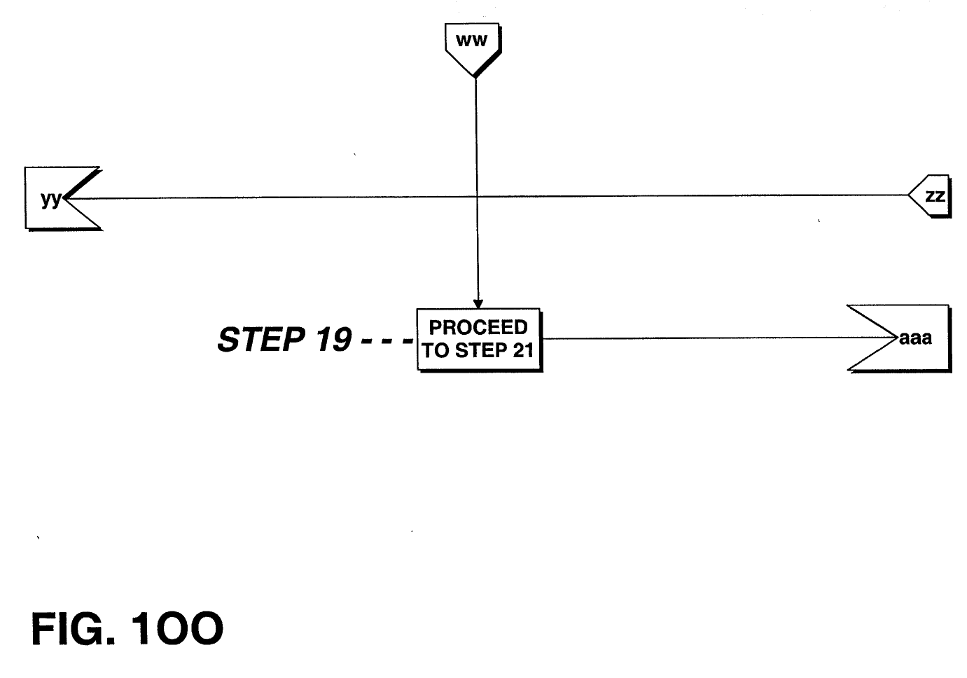

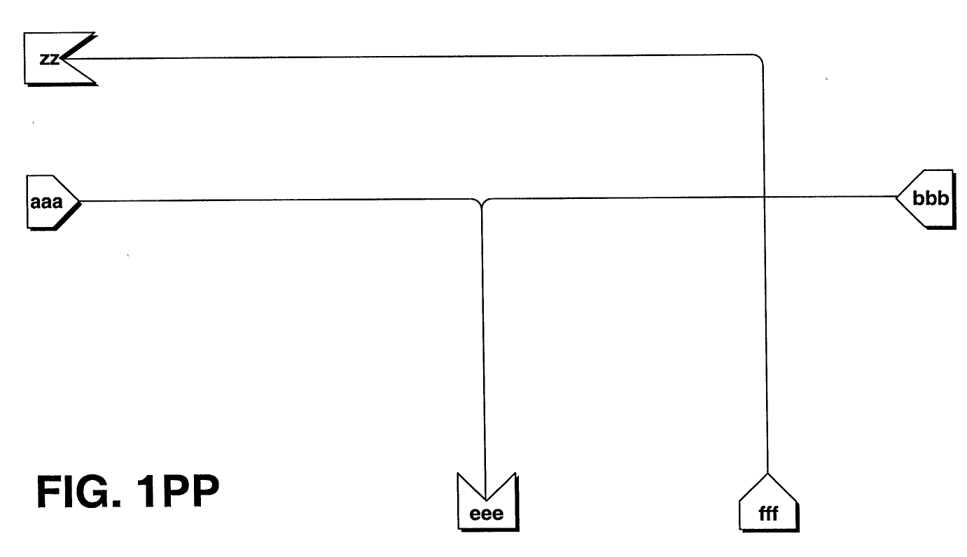

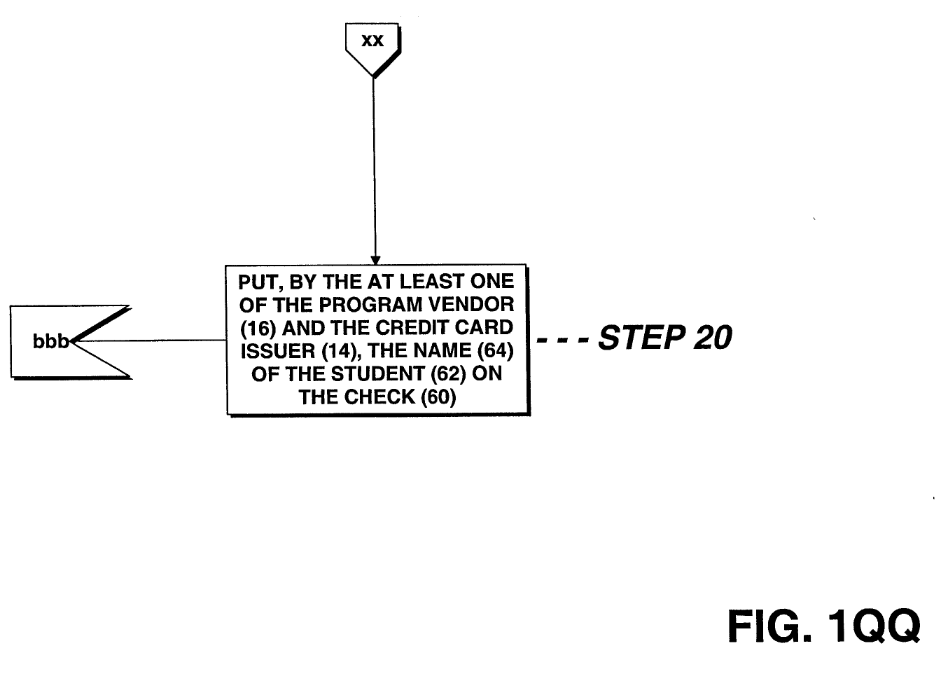

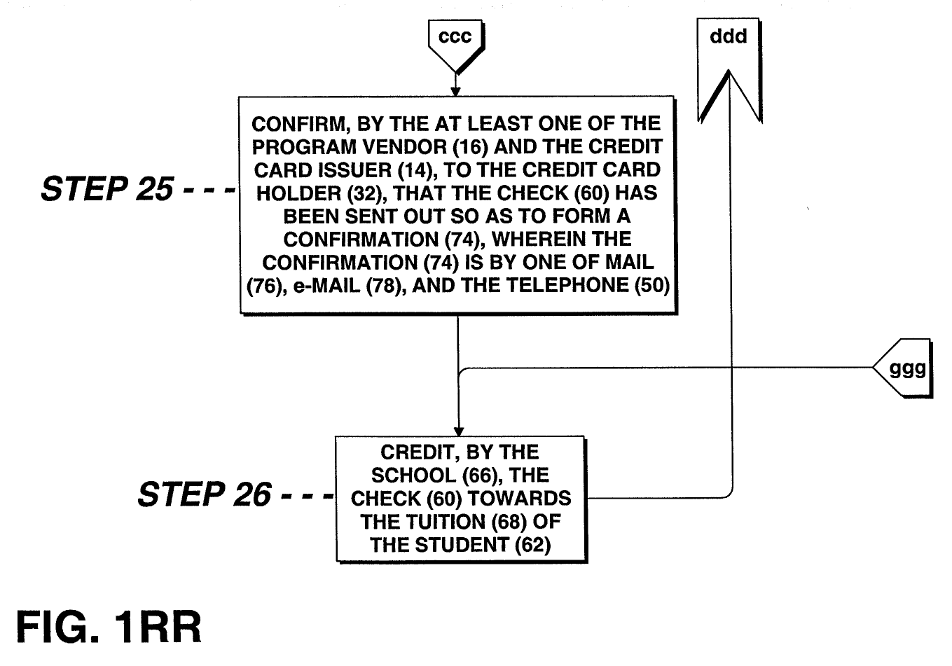

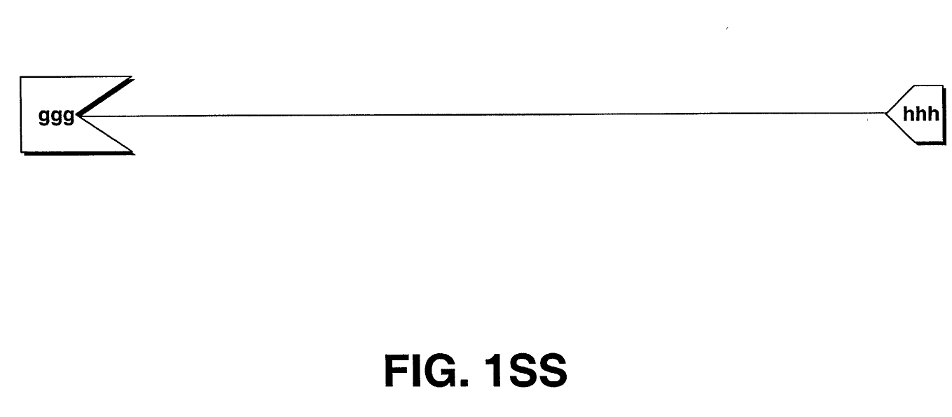

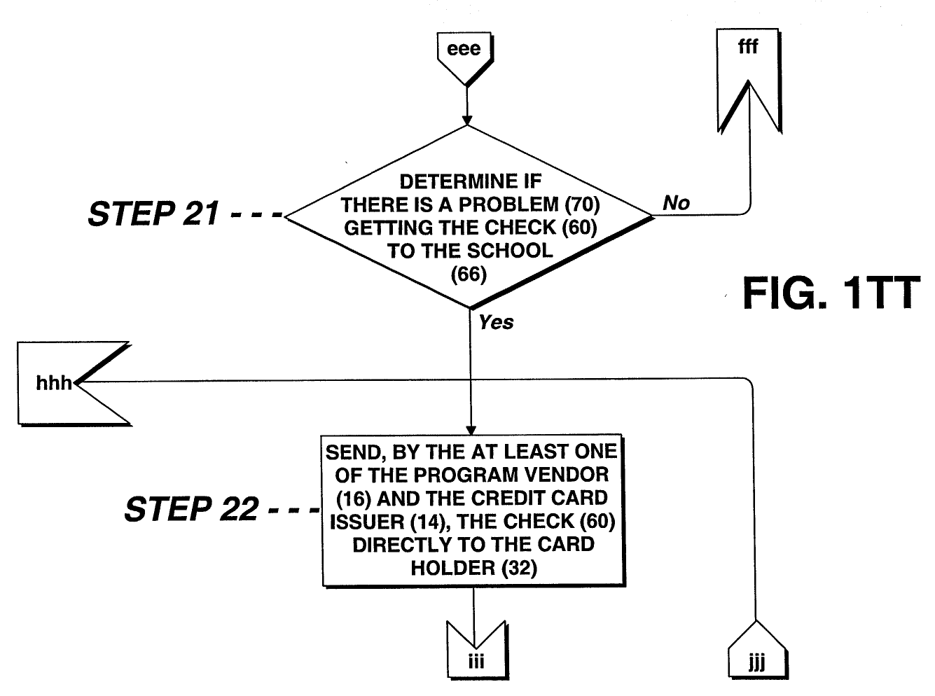

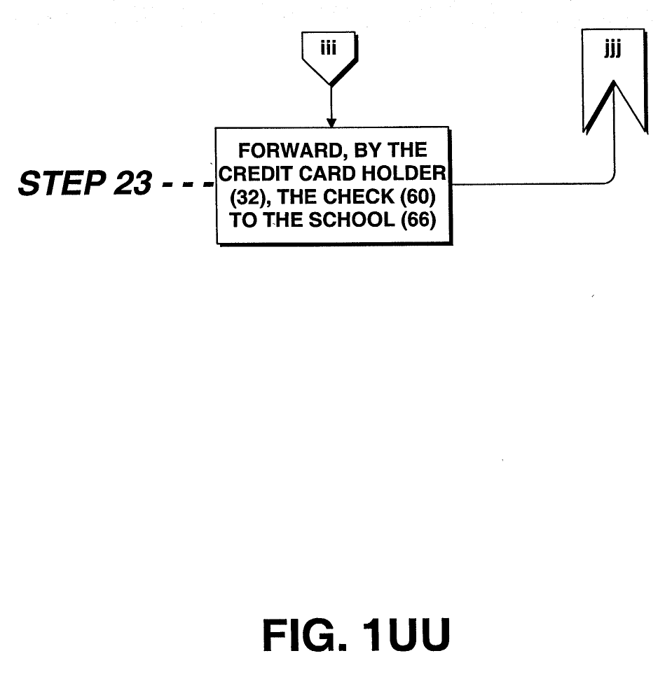

Referring now to FIGS. 1A-1UU, the method of providing a credit card driven tuition incentive awards program of the present invention is shown generally at 10 and comprises the following steps.

STEP 1: Pay out, by a credit card issuer 14, as per an agreement 12 between the credit card issuer 14 and a program vendor 16, a percentage of credit card sales 18 at a predetermined period 20, to the program vender 16, wherein the predetermined period 20 is one of monthly and quarterly.

STEP 2: Place, by at least one of the credit card issuer 14 and the program vendor 16, the percentage of credit card sales 18 in insured bank accounts 22 collecting set interest 24.

STEP 3: Keep optionally, by the at least one of the program vendor 16 and the credit card issuer 14, the set interest 24 for cost of operations 26.

STEP 4: Apply, by a potential credit card holder 28, for a credit card 30, to the credit card issuer 14.

STEP 5: Determine, by the credit card issuer 14, if the potential credit card holder 28 qualifies for the credit card 30.

STEP 6: Abort, if answer to STEP 5 is no.

STEP 7: Issue, by the credit card issuer 14, the credit card 30, to the potential credit card holder 28 so as to form a credit card holder 32, if answer to STEP 5 is yes, and as a result thereof, the credit card holder 32 automatically is approved for the credit card driven tuition incentive award program 10, by virtue of affiliation of the credit card driven tuition incentive award program 10 and the credit card issuer 14 with each other.

STEP 8: Pay, by the credit card holder 32, an annual fee 34, to at least one of the credit card issuer 14 and the program vendor 16 so as to form an account 36 with a balance 38 so as to form an account balance 40, if STEP 7 is carried out, wherein the annual fee 34 is predetermined.

STEP 9: Charge, by the credit card holder 32, an amount 42 on the credit card 30 so as to form an amount charged 43, if STEP 8 is carried out.

STEP 10: Accumulate, by the at least one of the program vendor 16 and the credit card issuer 14, a certain percentage 44 of the amount charged 42 on the credit card 30, by the credit card holder 32, if STEP 9 is carried out.

STEP 11: Convert, by the at least one of the program vendor 16 and the credit card issuer 14, the certain percentage 44 to points 46 so as to form points accumulated 48, if STEP 10 is carried out.

STEP 12: Check, by the credit card holder 32, the account balance 40, by one of telephone 50 and Internet 52, if STEP 11 is carried out.

STEP 13: Determine, by the credit card holder 32, if the points accumulated 48 are to be redeemed when the points accumulated 48 reach a predetermined amount 54.

STEP 14: Determine if the points accumulated 48 has reached the predetermined amount 54, if answer to STEP 13 is yes.

STEP 15: Return to STEP 9, if answer to STEP 14 is no.

STEP 16: Convert, by the at least one of the program vendor 16 and the credit card issuer 14, the points accumulated 48 to dollars 56 so as to form a dollar amount 58, if answer to STEP 14 is yes.

STEP 17: Issue, by the at least one of the program vendor 16 and the credit card issuer 14, a check 60 in the dollar amount 58, if STEP 16 is carried out.

STEP 18: Determine if the credit card holder 32 is not a student 62 who has a name 64 and who attends a school 66 with a tuition 68, if STEP 17 is carried out.

STEP 19: Proceed to STEP 21, if answer to STEP 18 is no.

STEP 20: Put, by the at least one of the program vendor 16 and the credit card issuer 14, the name 64 of the student 62 on the check 60, if answer to STEP 18 is yes.

STEP 21: Determine if there is a problem 70 getting the check 60 to the school 66.

STEP 22: Send, by the at least one of the program vendor 16 and the credit card issuer 14, the check 60 directly to the credit card holder 32, if answer to STEP 21 is yes.

STEP 23: Forward, by the credit card holder 32, the check 60 to the school 66, if STEP 22 is carried out.

STEP 24: Send, by the at least one of the program vendor 16 and the credit card issuer 14, the check 60 directly to the school 66, wherein each school 66 receives a distinct code number 72, if the answer to STEP 21 is no.

STEP 25: Confirm, by the at least one of the program vendor 16 and the credit card issuer 14, to the credit card holder 32, that the check 60 has been sent out so as to form a confirmation 74, wherein the confirmation 74 is by one of mail 76, e-mail 78, and the telephone 50, if STEP 24 is carried out.

STEP 26: Credit, by the school 66, the check 60 towards the tuition 68 of the student 62.

STEP 27: Call, by the credit card holder 32, the at least one of the program vendor 16 and the credit card issuer 14 so as to form a call 80, wherein the call 80 is by one of automated telephone 82 and the Internet 84, if answer to STEP 13 is no.

STEP 28: Determine if the call 80 is made within a predetermined time, if STEP 27 is carried out.

STEP 29: Request, by the credit card holder 32, redemption of the points accumulated 48, from the at least one of the program vendor 16 and the credit card issuer 14, if answer to STEP 28 is yes.

STEP 30: Return to STEP 24, if STEP 29 is carried out.

STEP 31: Forfeit automatically, the points accumulated 48, to the at least one of the program vendor 16 and the credit card issuer 14, if answer to STEP 28 is no.

It will be understood that each of the elements described above, or two or more together, may also find a useful application in other types of constructions differing from the types described above.

While the invention has been illustrated and described as embodied in a method of providing a credit card driven tuition incentive awards program, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A method of providing a credit card driven tuition incentive awards program, comprising the steps of:
a) paying out, by a credit card issuer, as per an agreement between the credit card issuer and a program vendor, a percentage of credit card sales at a predetermined period, to the program vender; and
b) placing, by at least one of the credit card issuer and the program vendor, the percentage of credit card sales in insured bank accounts collecting set interest.

2. The method as defined in claim 1; further comprising the steps of:
c) applying, by a potential credit card holder, for a credit card, to the credit card issuer;
d) determining, by the credit card issuer, if the potential credit card holder qualifies for the credit card;
e) aborting, if answer to step e) is no; and
f) issuing, by the credit card issuer, the credit card, to the potential credit card holder so as to form a credit card holder, if answer to step e), and as a result thereof, the credit card holder automatically is approved for the credit card driven tuition incentive award program, by virtue of affiliation of the credit card driven tuition incentive award program and the credit card issuer with each other.

3. The method as defined in claim 2; further comprising the step of:
g) paying, by the credit card holder, an annual fee, to at least one of the credit card issuer and the program vendor so as to form an account with a balance so as to form an account balance, if step f) is carried out.

4. The method as defined in claim 3; further comprising the steps of:
h) charging, by the credit card holder, an amount on the credit card so as to form an amount charged, if step g) is carried out; and
i) accumulating, by the at least one of the program vendor and the credit card issuer, a certain percentage of the amount charged on the credit card, by the credit card holder, if step h) is carried out.

5. The method as defined in claim 4; further comprising the step of:
j) converting, by the at least one of the program vendor and the credit card issuer, the certain percentage to points so as to form points accumulated, if step i) is carried out.

6. The method as defined in claim 5; further comprising the step of:
k) checking, by the credit card holder, the account balance, by one of telephone and Internet, if step j) is carried out.

7. The method as defined in claim 6; further comprising the steps of:
l) determining, by the credit card holder, if the points accumulated are to be redeemed when the points accumulated reach a predetermined amount;
m) determining if the points accumulated has reached the predetermined amount, if answer to step l) is yes; and
n) returning to step h), if answer to step m) is no.

8. The method as defined in claim 7; further comprising the steps of:
o) converting, by the at least one of the program vendor and the credit card issuer, the points accumulated to dollars so as to form a dollar amount, if answer to step m) is yes; and
p) issuing, by the at least one of the program vendor and the credit card issuer, a check in the dollar amount, if step o) is carried out.

9. The method as defined in claim 8; further comprising the steps of:
q) determining if the credit card holder is not a student who has a name and who attends a school with a tuition, if step p) is carried out;
r) proceeding to step t), if answer to step q) is no; and
s) putting, by the at least one of the program vendor and the credit card issuer, the name of the student on the check, if answer to step q) is yes.

10. The method as defined in claim 9; further comprising the steps of:
t) determining if there is a problem getting the check to the school;
u) sending, by the at least one of the program vendor and the credit card issuer, the check directly to the credit card holder, if answer to step t) is yes; and
v) forwarding, by the credit card holder, the check to the school, if step u) is carried out.

11. The method as defined in claim 10; further comprising the steps of:
w) sending, by the at least one of the program vendor and the credit card issuer, the check directly to the school, if the answer to step t) is no;
x) confirming, by the at least one of the program vendor and the credit card issuer, to the credit card holder, that the check has been sent out so as to form a confirmation, if step w) is carried out; and
y) crediting, by the school, the check towards the tuition of the student.

12. The method as defined in claim 11; further comprising the steps of:
z) calling, by the credit card holder, the at least one of the program vendor and the credit card issuer so as to form a call, if answer to step 11) is no; and
aa) determining if the call is made within a predetermined time, if step z) is carried out.

13. The method as defined in claim 12; further comprising the steps of:
bb) requesting, by the credit card holder, redemption of the points accumulated, from the at least one of the program vendor and the credit card issuer, if answer to step aa) is yes; and
cc) returning to step w), if step bb) is carried out.

14. The method as defined in claim 13; further comprising the step of:
dd) forfeiting automatically, the points accumulated, to the at least one of the program vendor and the credit card issuer, if answer to step aa) is no.

15. The method as defined in claim 1; further comprising the step of keeping, by the at least one of the program vendor and the credit card issuer, the set interest for cost of operations.

16. The method as defined in claim 1, wherein said step of paying out, by a credit card issuer, as per an agreement between the credit card issuer and a program vendor, a percentage of credit card sales at a predetermined period, to the program vender includes paying out, by a credit card issuer, as per an agreement between the credit card issuer and a program vendor, as percentage of credit card sales at a predetermined period being one of monthly and quarterly, to the program vender.

17. The method as defined in claim 6, wherein said step of checking, by the credit card holder, the account balance includes checking, by the credit card holder, the account balance, by one of telephone and Internet.

18. The method as defined in claim 11, wherein said step of sending, by the at least one of the program vendor and the credit card issuer, the check directly to the school includes sending, by the at least one of the program vendor and the credit card issuer, the check directly to the school that receives a distinct code number.

19. The method as defined in claim 11, wherein said step of confirming, by the at least one of the program vendor and the credit card issuer, to the credit card holder, that the check has been sent out so as to form a confirmation includes confirming, by the at least one of the program vendor and the credit card issuer, by one of mail, e-mail, and the telephone, to the credit card holder, that the check has been sent out so as to form a confirmation.

20. The method as defined in claim 12, wherein said step of calling, by the credit card holder, the at least one of the program vendor and the credit card issuer so as to form a call, includes calling, by the credit card holder, the at least one of the program vendor and the credit card issuer, by one of automated telephone and the Internet so as to form a call.
